(19) United States
(12) Patent Application Publication
(10) Pub. No.: US 2006/0168266 A1
(43) Pub. Date: Jul. 27, 2006

(54) Apparatus and method for providing signaling mediation for voice over internet protocol telephony

(75) Inventors: Leland Phillips, Dallas, TX (US); Sachin Vengurlekar, Plano, TX (US); James Robert Deerman, Lucas, TX (US); Miguel Garcia, Allen, TX (US)

Correspondence Address: Craig J. Cox;Suite 400, 2301 N. Greenville Avenue, Richardson, TX, 75082, US

(73) Assignee: tekVizion, Inc., Richardson, TX (US)

(21) Appl. No.: 10/989,878

(22) Filed: Nov. 20, 2004

(51) Int. Cl. G06F 15/16

(52) U.S. Cl. 709/230

(57) ABSTRACT

An apparatus and method are described that provide signaling mediation between different protocols, or different implementations of the same protocol, at network boundaries for voice over Internet Protocol telephony. The signaling mediation device translates control messages from one protocol, or implementation of a protocol, into another protocol, or implementation of a protocol based on the type of networks to which the signaling mediation device is connected. The signaling mediation device also includes profiles for the networks to which it is connected based on the type of equipment in those networks. The profiles provide additional mapping and translation based on implementation specific characteristics of the network equipment connected to the signaling mediation device.

### TECHNICAL FIELD OF THE INVENTION

The present invention relates to voice over Internet protocol (VoIP) networking equipment. Specifically, the present invention relates to a signaling mediation device and method of signaling mediation, which enables conflicting protocols and conflicting implementations of protocols to interact in a VoIP network.

### BACKGROUND OF THE INVENTION

Currently, the majority of consumers, businesses, and carriers, must maintain two separate networks. A public switched telephone network (PSTN) to carry analog voice telephone calls, and a data network to carry digital data services such as email, web access and other data information. Having two separate networks results in significant costs to implement and maintain separate networks using incompatible protocols and distinct equipment. There is and has been a move underway in the industry to try to consolidate these two distinct networks into a single network capable of carrying both data and voice over the same lines using the same equipment.

One way to resolve the two network problem is to get rid of the PSTN network and use the data network to carry voice traffic along side the existing data traffic. While this simplifies the overall network, it creates new issues, particularly for real-time services such as voice telephony. Most data networks, including the Internet, use protocols that are indifferent to the type of traffic being sent resulting in email and web traffic being treated the same as voice or video calls. As a result, when there is a large amount of traffic on the network or when a piece of equipment in the network fails, while not a problem for email or web services, the quality of real-time services like voice calls can become unacceptable.

Additionally, the data networks have devices such as firewalls and network address translation devices that interfere with the ability to properly connect calls between VoIP phones, and the data networks often use private IP address space meaning that two VoIP telephones can share the same address, making routing calls to those phones problematic.

Several different protocols have been developed to provide workable implementations for VoIP. The two most widely used protocols are session initiation protocol (SIP) and H.323. SIP is favored by network providers and telecom carriers while H.323 is more widely used in enterprise installations using equipment from vendors such as Cisco and Nortel. Because of this, there often exists at the enterprise/carrier edge a need to translate H.323 messaging into SIP for outgoing call messaging and SIP into H.323 for inbound call messaging. Because there is not a one-to-one mapping of H.323/SIP messages and services, some information can get lost at this boundary translation, and more importantly some services and applications cannot cross the protocol boundary.

There is a further problem besides just translating between protocols at boundaries. This problem lies in the fact that different vendors have implemented supposedly standard protocols, such as SIP and H.323, differently adding an additional layer of complexity to the problem. For example, Cisco's Call Manager has implemented H.323 messaging differently than Nortel's Sucession product. This implementation difference can occur both in the formatting of individual messages and the information contained in those messages, as well as the when and how the messages are sent. This means that not only is a device needed that can translate between conflicting protocols, a device is needed that can translate between different implementations of the same protocol.

Accordingly, what is needed is a device and method for translating between VoIP protocols which is aware of the exact devices to which it is connected and can translate not only between protocols, but can also translate between different implementations of the same protocol. Further, a device and method are needed that allow for services and applications to cross protocol translation boundaries.

### SUMMARY OF THE INVENTION

The present invention provides for a method and apparatus to provide signaling mediation between networks employing conflicting protocols. The signaling mediation device of the present invention includes interfaces for receiving messages for one or more network employing conflicting protocols, the interfaces connected to termination functions. The termination functions are operable to provide an end point for the messages of one protocol, such as an end point function for H.323 or a user agent function for SIP. The termination function takes the information about the type of message received and the information contained within the message itself, such as setup information, and provides the information to an inter-working function.

The inter-working function operates to provide a translation from one protocol into another protocol by mapping messages and information between protocols. The inter-working function sends the translation to the termination function of the other network which generates the appropriate message and places it on the network with the conflicting protocol. The signaling mediation device further contains a profile with implementation specific information for each network. The profile allows the signaling mediation device to translate from one protocol to another but to also translate between different implementations of the same protocol and to allow for implementation specific irregularities based on the type of equipment to which the signaling mediation device is connected.

A method of providing signaling mediation between networks with conflicting protocols is also described. The method receives a message using a first protocol from a first network. The method then translates the message into a second protocol using a profile that contains implementation specific information to aid in performing the translation. Finally, the method then sends the translated message on the second network employing the second protocol.

Finally, the present invention provides for a method of tunneling service information across a network employing a protocol incompatible with the service information. The method begins by receiving a message containing service information using a first protocol at a first signaling mediation device. The first signaling mediation device then creates a message using a second protocol and attaches the service information to the message using the second protocol. The message is then sent to a second signaling mediation device, which takes the services information and creates a services message using the first protocol.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art will appreciate that they can readily use the disclosed conception and specific embodiment as a basis for designing or modifying other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 is a simplified network diagram of a network implementing a session mediation device according to the present invention;

FIG. 2 is a diagram of a session mediation device according to the present invention;

FIG. 3 is a call flow showing call establishment control messaging across the network of FIG. 1;

FIG. 4 is a call flow showing call termination control messaging across the network of FIG. 1;

FIG. 5 is a call flow showing call feature/service translation across the network of FIG. 1.

FIG. 6 is the diagram of a SIP message with H.323/H.450 messages attached to tunnel feature/service instructions across the carrier network; and

FIG. 7 is a sample profile illustrating implementations of a hold protocol across equipment with incompatible protocols.

### DETAILED DESCRIPTION OF THE DRAWINGS

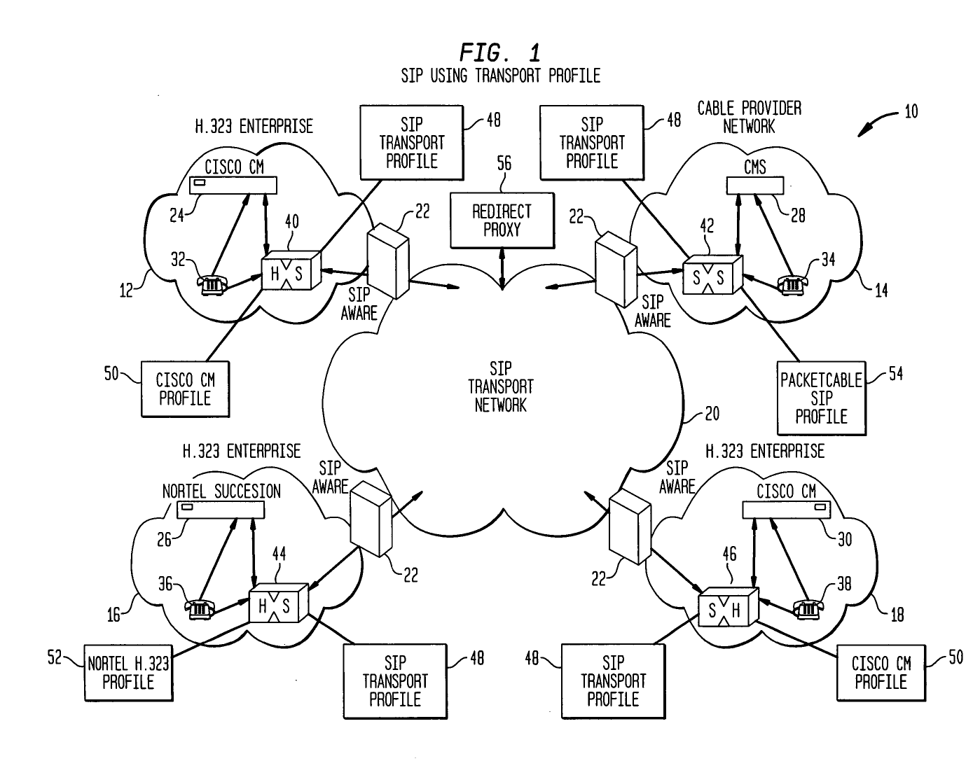

Referring now to FIG. 1, a simplified network diagram of a network 10 for transmitting VoIP calls is shown. The network consists of enterprise networks 12, 14, 16 and 18, which connect to SIP transport network 20 through SIP aware firewalls 22. Enterprises 12, 16 and 18 use H.323 as the VoIP protocol within the enterprise network. Enterprises 12 and 18 use a Cisco Call Manager (CM) to control H.323 traffic in the network, while enterprise 16 uses a Nortel Sucession device for H.323 traffic. Enterprise 14 uses CMS 28 to manage an enterprise SIP implementation. While Cisco and Nortel devices are shown in enterprises 12, 14 and 18, these are for illustration only, one skilled in the art will understand that any vendor's H.323 VoIP controller can be used without departing from the scope of the present invention.

Since enterprises 12, 14 and 18 are using H.323 as their internal VoIP protocol and the carrier is using SIP for its transport network 20, a device is needed to perform the translation between H.323 and SIP for enterprises 12, 14 and 18. To perform this translation, a signaling mediation device (SMD) according to the present invention is used. SMDs 40, 42 and 46 are operable to translate VoIP control messages between H.323 and SIP. A problem arises from the fact that although H.323 and SIP are standards based protocols, each vendor's implementation of the protocol in its equipment can vary slightly. For example, information contained in a H.323 or SIP message can be formatted slightly differently or the order of H.323 or SIP messages from one vendor's device may be slightly different than the order of messages from another device. These vendor differences can cause serious problems in a VoIP network, such as network 10.

SMDs 40, 42, 44 and 46, in accordance with the present invention include implementation based profiles based on the particular equipment to which the SMD is connected. SMD 40 in enterprise 12 is connected to a Cisco Call Manager 24 on the enterprise side and to the SIP transport network 20 on the public side. Therefore, SMD 40 has a profile 50 for a Cisco Call Manager added to its H.323 translation function and a SIP transfer profile 48 added to its SIP translation function. Using profiles 48 and 50, SMD 40 not only is able to translate between H.323 and SIP according to the standards requirements, but also to further add implementation based translation such that the Cisco Call Manager 24 sees the H.323 messages as is expected based on Cisco's implementation of H.323, and further that in the translation from Cisco H.323 to SIP any implementation issues can be recognized and properly translated.

The same holds true for the SIP transport profile 48. SIP transport network 20 uses specific vendor equipment that determines the content of SIP transport profile 48. Since different SIP networks use different equipment from different vendors, the SIP transport profile is chosen specifically to accommodate the vendor equipment in the network to which it is connected.

Enterprise 18 shows the same architecture as enterprise 12 and, therefore, uses the same Cisco Call Manager profile 50 and SIP transport profile 48 as enterprise 12. Enterprise 16 uses a Nortel Sucession device 26 for its gate keeper function and therefore has a Nortel H.323 profile 52 in addition to the SIP transport profile 48. The use of SMDs and profiles is not limited to points where different network protocols interface. The SMD can also be used to interface between different implementations of the same protocol, as is shown with SMD 42 in enterprise 14. Enterprise 14 is shown as a cable provider using SIP in the example of network 10. Enterprise 14 uses a SIP CMS 28 for its intra-enterprise call functions and, therefore, has packet cable SIP profile 54 added to SMD 42, as well as SIP transport profile 48, to provide seamless translation between different implementations of SIP between the two networks.

The use of the equipment aware SMDs 40, 42, 44 and 46 in FIG. 1 allow IP phones 32, 34, 36 and 38 to place calls to each other through SIP transport network 20 without any problems stemming from the differing protocols used in the networks or any problems that might occur from different implementations of the same protocol.

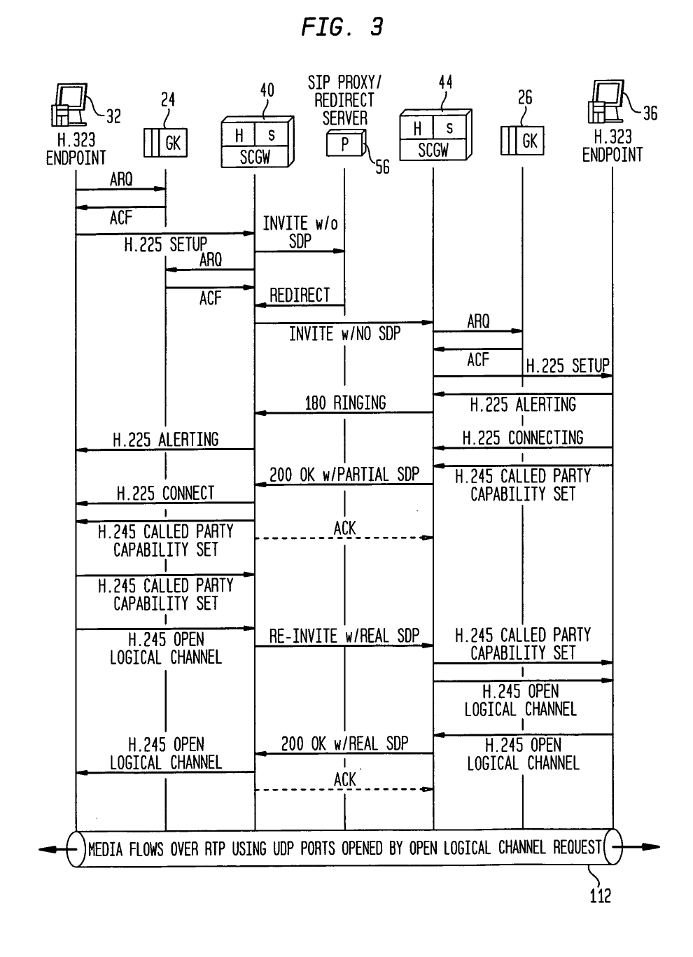

To illustrate the operation of network 10, a call between IP phone 32 in enterprise 12 and IP phone 36 in enterprise 16 will be described. More detailed call flows will be described with reference to FIGS. 3-5. IP phone 32, using H.323, sends an admission request to the gate keeper for enterprise 12, which in this case is Cisco Call Manager 24. The Cisco Call Manager 24 responds with an admission confirm message. IP phone 32 then sends an H.323 setup message to SMD 40, which translates the message from Cisco Call Manager H.323 to the SIP of SIP transport network 20 using profiles 48 and 50. The resulting translated message, a SIP INVITE message, is sent to SIP proxy/redirect server 56, which looks up the proper IP address for called IP phone 36 and responds to SMD 40 with that information. SMD 40 then resend the SIP invite to SMD 44 where it is translated from SIP to Nortel H.323 using profiles 48 and 52. The translated H.323 message is then sent to IP phone 36 after proper admission authentication by the gate keeper, here Nortel Sucession 26. A more detailed call set-up call flow is described with reference to FIG. 3.

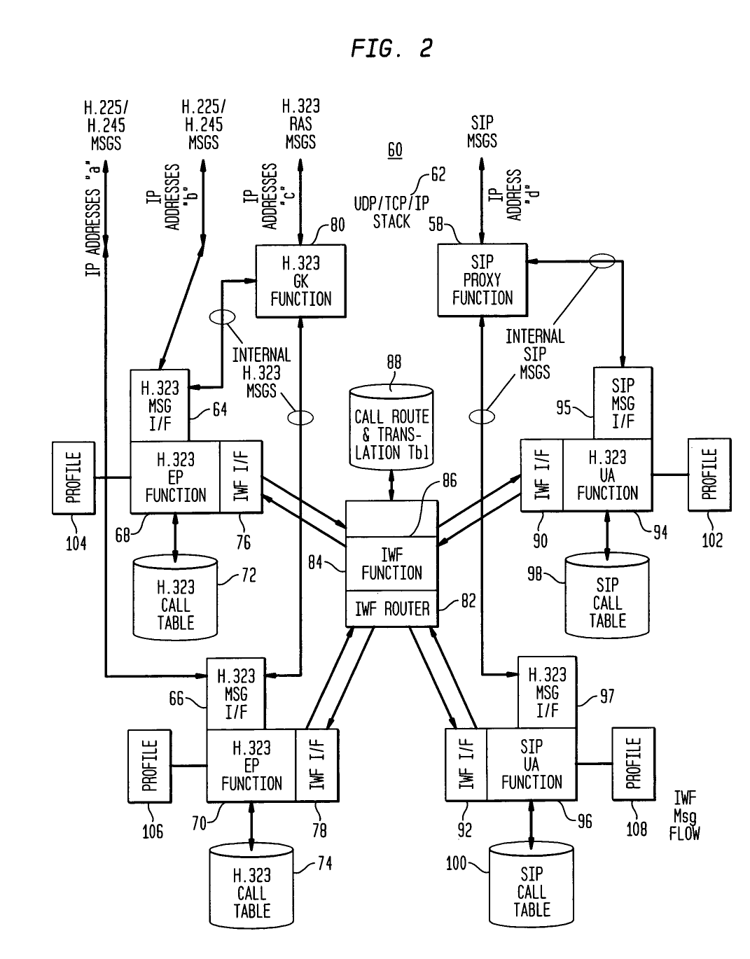

Referring now to FIG. 2, a block diagram of an SMD, such as SMD 40, 42, 44 or 46 from FIG. 1, in accordance with the present invention is shown. The SMD 60 of FIG. 2 may be implemented in either hardware or software, but the preferred implementation is as software running on a general purpose server. The external interfaces for SMD 60 are IP addresses, shown as IP address “a”, IP address “b”, IP address “c”, and IP address “d”, at which SMD 60 receives VoIP control packets such as H.323 or SIP control packets. The IP addresses interface with UDP/TCP/IP stack 62 which buffers input and output traffic and forwards packets to their proper destination.

While SMDs 40, 42, 44 and 46 of FIG. 1 are shown as providing an interface between two networks, an SMD according to the present invention can serve as an interface between any number of networks. SMD 60 of FIG. 2 illustrates this by showing an SMD acting as an interface between two H.323 networks and two SIP networks, although any number of networks could be accommodated according to the principles of the present invention.

From UDP/TCP/IP stack 62, H.323 messages received on IP addresses “a” and “b” are sent to the corresponding H.323 message interfaces 64 and 66. From messages interfaces 64 and 66 the messages are passed to end point function 68 and 70. Because each H.323 call and SIP call must each have two distinct end points, or user agents for SIP, SMD 60 before it can provide the translation function must act as an end point for each call. This is done by H.323 end point functions 68 and 70. End point functions 68 and 70 maintain H.323 call tables 72 and 74 to keep status on all active H.323 calls passing through SMD 60. H.323 end point functions 68 and 70 also interface with profiles 104 and 106 respectively. Profiles 104 and 106 are the equipment specific profiles for the H.323 networks to which SMD 60 is connected. For example, profile 104 could be to a Cisco Call Manager profile if the VoIP network connected to IP address “b” is a Cisco H.323 network. Similarly, profile 106 could be a Nortel profile if IP address “a” is connected to a Nortel H.323 network.

H.323 end point functions 68 and 70 receive H.323 messages and extract the required information. This information along with information on the type of H.323 message received needs to be translated by inter-working module 82 to be sent onto the network on the other side of SMD 60. H.323 end point functions 68 and 70 connect to inter-working module 82 through IWF interfaces 76 and 78, respectively. H.323 end point functions 68 and 70 tell inter-working module 82 when an H.323 control message has been received and needs to be translated. Inter-working module 82 uses call route and translation table 88 to provide the translation between protocols or implementations of protocols. Inter-working module 82 includes IWF router 84 and IWF function 86. IWF router 84 is used to ensure that packets are sent to and from their associated end points or user agents if more than one end point or user agent is connected to one side of inter-working function 82. IWF function 86 provides the actual translation of protocols or implementations, based on mapping stored in call route and translation table 88.

After translation by inter-working module 82, the information required to send the appropriate SIP message is sent from inter-working module 82 to the appropriate IWF interface 90 or 92, which passes the information to SIP user agent functions 94 and 96. As with the H.323 end point functions, the SIP user agents act as an end point, in this case the origination point, for each SIP call. SIP user agents 94 and 96 maintain SIP call tables 98 and 100 which hold call status for all active SIP calls being managed by the SIP user agents. In addition, SIP user agents 94 and 96 interface with profiles 102 and 108, which contain the implementation specific information for particular equipment to which SIP user agents 94 and 96 are connected. SIP user agent functions 94 an 96 then generate the appropriate SIP message based on the translation from H.323 and send it out on IP address “d” using SIP message interfaces 95 and 97 and UDP/TCP/IP stack 62. SMD 60 may also include a SIP proxy function, shown as SIP proxy function 58, which acts as a proxy for all SIP calls entering or leaving SMD 60. The SIP proxy function can also be handled by a separate device external to SMD 60.

While the working of SMD 60 has been described with respect to taking a message received on the H.323 side and translating for transmission on the SIP side, in the example of FIG. 2, the message flow works in the same manner for messages received on the SIP side and need to be forwarded from the H.323 side of SMD 60.

Also, while the SMD is shown in a specific embodiment as a stand alone network device connected to other network devices, other embodiments could be envisioned where the SMD was a software module connected to other software modules on a larger piece of network equipment, or where the SMD of the present invention interconnected to other equipment or software modules while still performing the same functionality, all without departing from the scope of the invention as described herein.

Referring now to FIG. 3, a call flow showing a call set up procedure for a VoIP network, such as network 10 from FIG. 1, is described. To illustrate the call set up call flow reference will be made to specific equipment in FIG. 1, such as IP phones 32 and 36, gate keepers 24 and 26, SMDs 40 and 44, and SIP redirect server 56. The call set up shows a call being placed from IP phone 32 in enterprise 12 to IP phone 36 in enterprise 16. The user of IP phone 32 initiates the call by dialing the phone number for IP phone 36. IP phone 32 generates an admission request message ARQ which is sent to gate keeper 24, shown in FIG. 1 as a Cisco Call Manager. Gate keeper 24 responds with an admission confirm message ACF. IP phone 32 then sends a setup message H.225 Setup to SMD 40. SMD 40 receives the setup message H.225 Setup, and translates that into a SIP invite message INVITE w/o SDP, which is sent to SIP redirect server 56 where the proper IP address for the dialed phone number is sent via a redirect message REDIRECT. At the same time SMD 40 responds with an admission request ARQ to gate keeper 24 and receives an admission confirm ACF in response.

In response to the redirect message REDIRECT from SIP redirect server 56, SMD 40 resends the invite message INVITE w/o SDP to SMD 44. The invite message is an incomplete message as shown by the lack of session description protocol information (SDP) since the initial H.323 setup message does not contain all the necessary information for a complete SIP INVITE message. SMD 44 receives the invite message and generates an admission request ARQ to gate keeper 26, shown in FIG. 1 as a Nortel Sucession device. Gate keeper 26 responds with an admission confirm ACF to SMD 44, which then generates an H.225 setup message sent to IP phone 36.

IP phone 36 responds with an H.225 alerting message H.225 ALERTING to SMD 44 which translates the message into a SIP ringing message 180 RINGING for SMD 40, which is then translated back into a H.225 alerting message H.225 ALERTING sent to IP phone 32. IP phone 36 follows the alerting message with a connect message H.225 CONNECT and a message with call parameters H.245 CALLED PARTY CS. These two messages are translated by SMD 44 into a SIP message 200 OK w/partial SDP which is translated back into two H.323 messages by SMD 40, H.225 CONNECT and H.245 CALLED PARTY CS for IP phone 32. SMD 40 also responds to SMD 44 with a SIP acknowledgement ACK.

Once IP phone 32 receives the capability set (CS) from IP phone 36 it responds with its own capability set H.245 CALLING PARTY CS, and a message to open the media or logical channel (LC) H.245 OPEN LC. SMD 40 translates this into a SIP re-invite message RE-INVITE w/real SDP to SMD 44, which translates it back into the capability set message H.245 CALLING PARTY CS and message to open the media channel H.245 OPEN LC. IP phone responds with its own message to open the media channel H.245 OPEN LC, which is translated to a SIP 200 OK message w/real SDP message by SMD 44 and sent to SMD 40 where it is retranslated into a H.245 OPEN LC message for IP phone 32. SMD 40 then responds with and acknowledgement ACK to SMD 44. With all the necessary call setup information exchanged, IP phones 32 and 36 establish media channel 112 which is a UDP session directly between phones in an H.323 or SIP call.

Again, while H.323 and SIP were used to illustrate the operation of SMDs in network 10 of FIG. 1, the SMDs of the present invention can be used to provide interfaces between any incompatible protocols or implementations of protocols for real-time services over and IP network.

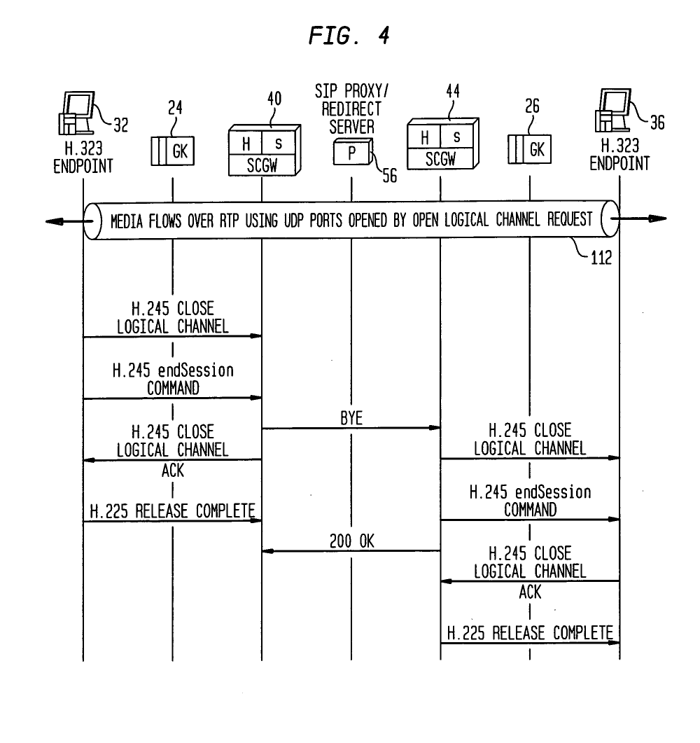

Referring now to FIG. 4, a call flow illustrating call termination for a VoIP call over network 10 of FIG. 1 is described. An established call using a media stream such as media stream 112, set up as described with reference to FIG. 3, is ended with the user of either IP phone 32 or 36 hanging up. In the illustration of FIG. 4 the user of IP phone 32 hangs up causing IP phone 32 to generate and H.245 CLOSE LC message and a H.245 END SESSION command. These messages are translated by SMD 40 into a SIP BYE message and sent to SMD 44, which retranslates the SIP BYE message back into H.245 CLOSE LC and H.245 END SESSION messages.

At the same time SMD 40 sends an H.245 CLOSE LC ACK acknowledgment message back to IP phone 32, which responds with a H.225 RELEASE COMPLETE message. IP phone 36 generates a H.245 CLOSE LC ACK acknowledgement message in response to the H.245 CLOSE LC message and SMD 44 sends a SIP 200 OK message to SMD 40 and also responds to IP phone 36 with a H.225 RELEASE COMPLETE message.

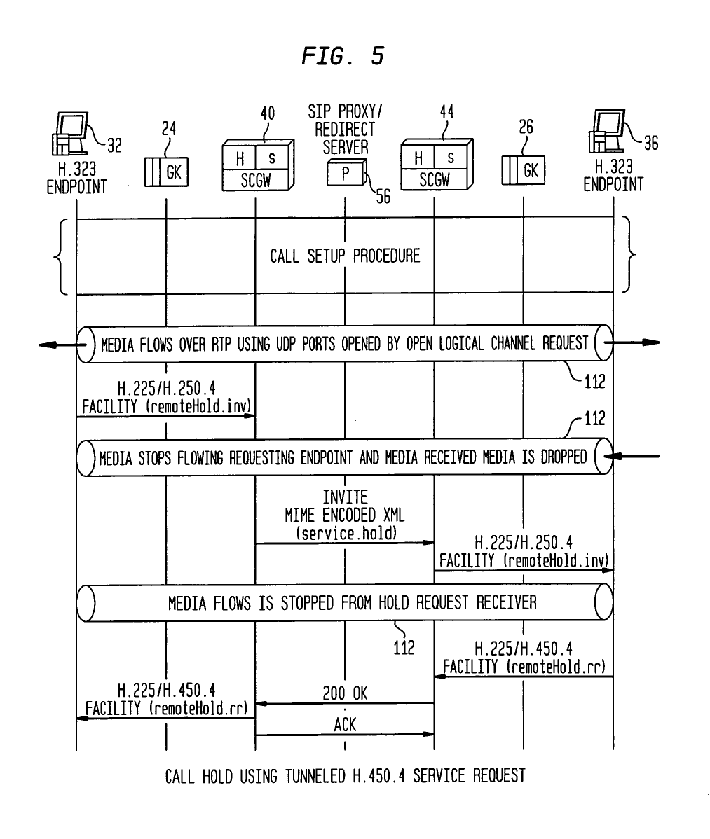

Referring now to FIG. 5, a call flow illustrating using VoIP services over network 10 of FIG. 1 is described. Another problem encountered when routing calls across networks with different protocols, such as H.323 and SIP, is the inability to passes services like VoIP services such as HOLD, TRANSFER, and other services, across the networks because of an inability to map services between protocols. FIG. 5 shows a call flow for a service, HOLD, that happens to map fairly straight forwardly between protocols, but other services either map very awkwardly, or do not map at all between protocols, preventing the use of many services between phones on different networks. In FIG. 5, an established media stream 112 is open between phones after a call setup procedure such as that shown in FIG. 3. The user of IP phone 32 presses hold on IP phone 32, which generates an H.225/H.450 FACILITY (remotehold.inv) message. In a network, such as network 10 from FIG. 1, where two SMDs according to the present invention are acting as SIP user agents, or H.323 end points, as appropriate, the service message, such as the H.225/H.450 hold message of the present example, is encoded into a SIP message, such as by MIME encoded XML, (as shown in FIG. 7) and tunneled across the carrier network. In the case where there is not another SMD on the receiving end of the VoIP call, SMD 40 is able to recognize and translate the service message into the equivalent, or near equivalent message(s) using the protocol of the carrier network. Here, for example, the H.323 hold message would be translated into a SIP INVITE message with an SDP: c=0.0.0.0. After IP phone sends the hold request message it breaks its media connection 112 by stopping sending packets on the UDP connection and by dropping those packets received on the connection.

This SIP message is recognized by SMD 44 which translates it back into the H.225/H.450 FACILITY (remotehold.inv) message for IP phone 36 which breaks its media connection 112 and sends an H.225/H.450 FACILITY (remotehold.rr) message to SMD 44. SMD 44 translates that message into a SIP 200 OK message for SMD 40, which retranslates and sends the H.225/H.450 message to IP phone 32 and also responds to SMD 44 with an acknowledgement message ACK.

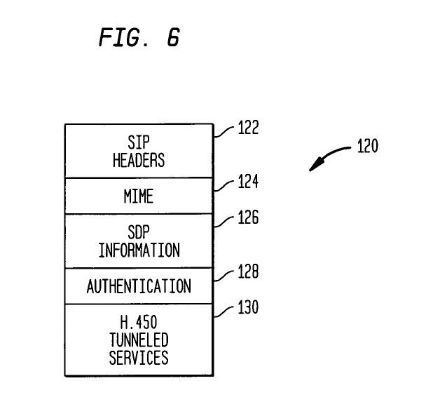

For those messages that do not translate between protocols easily or at all, a way to tunnel those services across protocols would be desirable. One method of tunneling these services would be to embed the service requests in messages between the SMDs of the present invention. The SMDs of the present invention can be set up to recognize when they are connected to one another such as across SIP transport network 20 in FIG. 1. If the SMDs know that they are communicating with a like device they can embed services information in packets sent between them eliminating the need for awkward or impossible translations of services between protocols. One method of this tunneling is shown in FIG. 6.

Referring now to FIG. 6, a diagram of a typical SIP message is shown. SIP message 120 is used to carry information about SIP calls. SIP headers 122 are text based and carry basic SIP messaging information. In addition, however, the SIP protocol allows for attachment to SIP messages using multi-purpose internet mail extension (MIME) attachments. MIME headers 124 indicate an attachment which in the case of SIP messages can be SDP information 126 to pass setup information between SIP devices, or authentication information 128.

An SMD of the present invention can make further use of the ability to add attachments to the SIP message if the SMD knows that there is another SMD on the other end of the transmission that can make use of the attached information. Specifically, H.450 services information 130 can be attached to a SIP message between SMDs. The receiving SMD can strip the H.450 information from the SIP message and use its H.323 end point function to generate the proper H.450 services messages. By attaching services messaging to a message such as SIP message 120, SMDs can tunnel services across conflicting protocol networks without having to attempt awkward translations.

Referring now to FIG. 7, a sample profile is shown. Sample profile 150 is a simplified profile for illustrative purposes and shows the translation of a hold function for a Cisco Call Manager version 3.0 in communication with a generic SIP network. Profile 150 shows that a terminal capability set (TCS) with nor parameters set followed by a close logical channel (CLC) message is used with the Cisco Call Manager to implement a hold in the generic SIP network.

While profile 150 shows the handling of a hold message between a Cisco Call Manager network and a generic SIP network, one skilled in the art would understand that the profiles of the present invention can be used to translate not only between conflicting protocols, but also account for differences in implementations of protocols specific to individual vendor's equipment.

Although particular references have been made to specific protocols, such as SIP and H.323, implementations and materials, those skilled in the art should understand that the signaling mediation device can function with a variety of other protocols including non-peer-to-peer protocols such as MGCP, and in non-IP networks, as well as in a variety of different implementations without departing from the scope of the invention. Although the present invention has been described in detail, those skilled in the art should understand that they can make various changes, substitutions and alterations herein without departing from the spirit and scope of the invention in its broadest form.

We claim:

1. A signaling mediation device for translating protocols between entities with conflicting protocols, comprising:
interfaces to each entity;
termination functions to provide an end point for the protocol of each entity; and
an inter-working function connected to the termination function and operable to provide translation between the conflicting protocols;
wherein the signaling mediation device includes profiles containing information on the specific implementation of each protocol for each entity.

2. The signaling mediation device of claim 1 wherein one of the protocols is H.323.

3. The signaling mediation device of claim 1 wherein one of the protocols is session initiation protocol.

4. The signaling mediation device of claim 1 wherein the profiles correspond to implementations of the protocol specific to a particular equipment vendor.

5. The signaling mediation device of claim 1 further operable to tunnel services information across the entity using the conflicting protocol.

6. The signaling mediation device of claim 1 wherein the conflicting protocols are different voice over Internet Protocol protocols.

7. The signaling mediation device of claim 1 wherein the conflicting protocols are different implementations of the same protocol.

8. The signaling mediation device of claim 1 wherein the entities are networks.

9. The signaling mediation device of claim 1 wherein the entities are software modules.

10. A method of providing signaling mediation between entities using conflicting protocols, comprising:
receiving a message from a first entity using a first protocol;
translating the message from the first protocol into a second protocol, wherein implementation specific information contained in a first profile for the first protocol is used to perform the translation; and
sending the message on a second entity using the second protocol.

11. The method of claim 10 wherein implementation specific information is contained in a second profile for the second protocol is also used to perform the translation.

12. The method of claim 10 wherein the first and second profiles are included in a fist and second termination function, respectively.

13. The method of claim 12 wherein the first and second termination functions operate to provide end points for messaging on the first and second networks.

14. The method of claim 10 wherein the first protocol is a H.323 voice over internet protocol protocol.

15. The method of claim 10 wherein the first protocol is a session initiation protocol.

16. The method of claim 10 wherein the first and second protocols are conflicting voice over Internet protocol protocols.

17. The method of claim 10 wherein the first and second protocols are conflicting implementations of the same voice over internet protocol protocol.

18. The method of claim 10 wherein the first profile is specific to a particular vendor's equipment.

19. A method of passing service information between networks using conflicting protocols, comprising:
receiving a services message from a first network using a first protocol at a first signaling mediation device;
creating a message using a second protocol with the first signaling mediation device
attaching the services information to the message; and
sending the message on a second network to a second signaling mediation device, the second mediation device operable to retrieve the services information from the message.

20. The method of claim 17 wherein the first protocol is H.323 and the second protocol is session initiation protocol.
